(19) United States
(12) Patent Application Publication
(10) Pub. No.: US 2018/0309192 A1
(43) Pub. Date: Oct. 25, 2018

(54) DETACHABLE ANTENNA CONNECTOR CABLE FOR FIXED ANTENNA PORT

(71) Applicant: ALFA NETWORK INC., Taipei City (TW)

(72) Inventor: CHIANG-SHENG WANG, Taipei City (TW)

(21) Appl. No.: 15/493,142

(22) Filed: Apr. 21, 2017

(51) Int. Cl. H01Q 1/24; H01Q 1/12

(52) U.S. Cl. CPC H01Q 1/246; H01Q 1/1207

(57) ABSTRACT

A detachable antenna connector cable for a fixed antenna port includes: a connector body, a raised ring being wound around an outer side thereof; an antenna connecting portion, configured on one end of the connector body, a conducting wire being configured inside the antenna connecting portion, one end of the conducting wire being in connection with the antenna connecting portion, another end of the conducting wire being passed through another end of the connector body and extended outward; and an elastic engagement portion, configured on another end of the connector body, thereby providing an object of convenient assembly and disassembly.

### (a) TECHNICAL FIELD OF THE INVENTION

The present invention relates to a detachable antenna connector cable for a fixed antenna port, and more particularly to a detachable antenna connector cable for a fixed antenna port capable of convenient assembly and disassembly.

### (b) DESCRIPTION OF THE PRIOR ART

With advances in science and technology, humans are increasingly dependent on mobile devices, wireless transmission devices and wireless networks so that the antennas used to transmit or receive radio waves are also widely installed in the living environment. In terms of current available wireless access points (WAP), they generally include a case having a control circuit board, antenna connector and antenna, where the antenna connector is in electric connection with the control circuit board and antenna, where the control circuit board is adapted to receive radio waves and then emit them to the outside through the antenna connector and antenna.

However, the above wireless access points have the disadvantage: the antenna connector is fixed to the case such that the antenna connector cannot be assembled and disassembled; if the antenna is damaged, the entire WAP is difficult to be repaired and must be discarded as junk.

### SUMMARY OF THE INVENTION

The main objective of the present invention is to provide a detachable antenna connector cable for a fixed antenna port, capable of convenient assembly and disassembly.

To achieve the object mentioned above, the present invention proposes a detachable antenna connector cable for a fixed antenna port, including: a connector body, a raised ring being wound around an outer side thereof; an antenna connecting portion, configured on one end of the connector body, a conducting wire being configured inside the antenna connecting portion, one end of the conducting wire being in connection with the antenna connecting portion, another end of the conducting wire being passed through another end of the connector body and extended outward; and an elastic engagement portion, configured on another end of the connector body, thereby providing the object of convenient assembly and disassembly.

According to the detachable antenna connector cable for a fixed antenna port mentioned above, a positioning raised block is further configured between the raised ring and elastic engagement portion.

According to the detachable antenna connector cable for a fixed antenna port mentioned above, a thread portion is configured around an outer side of the antenna connecting portion.

According to the detachable antenna connector cable for a fixed antenna port mentioned above, the elastic engagement portion is constituted by two symmetric buckle blocks.

### BRIEF DESCRIPTION OF THE DRAWINGS

FIG. 1 is a perspective view of a preferred embodiment of the present invention;

FIG. 2 is a schematic view of the embodiment of the present invention in combination with a wireless access point (WAP); and

FIG. 3 is an exploded view of the embodiment of the present invention in combination with a wireless access point.

### DETAILED DESCRIPTION OF THE PREFERRED EMBODIMENTS

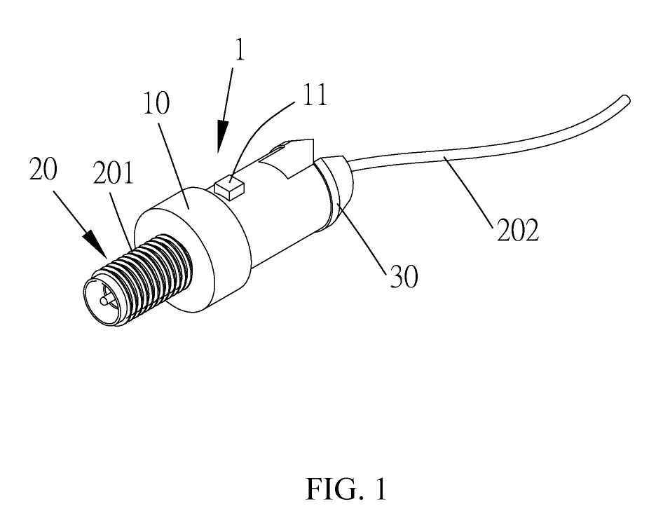

Referring to FIG. 1, which is a perspective view of a preferred embodiment of the present invention, a detachable antenna connector cable for a fixed antenna port includes: a connector body 1, a raised ring 10 being configured around the outer side thereof; an antenna connecting portion 20, configured on one end of the connector body 1, a conducting wire 202 being configured inside the antenna connecting portion 20, one end of the conducting wire 202 in connection with the antenna connecting portion 20, another end thereof being passed through another end of the connector body 1 and extended outward, and a thread portion 201 being configured around the outer side of the antenna connecting portion 20; and an elastic engagement portion 30, configured on another end of the connector body 1 and constituted by two symmetric buckle blocks, where a positioning raised block 11 is further configured between the elastic engagement portion 30 and raised ring 10, thereby allowing the coupling joint for a replaceable antenna connector to be convenient for assembly and disassembly.

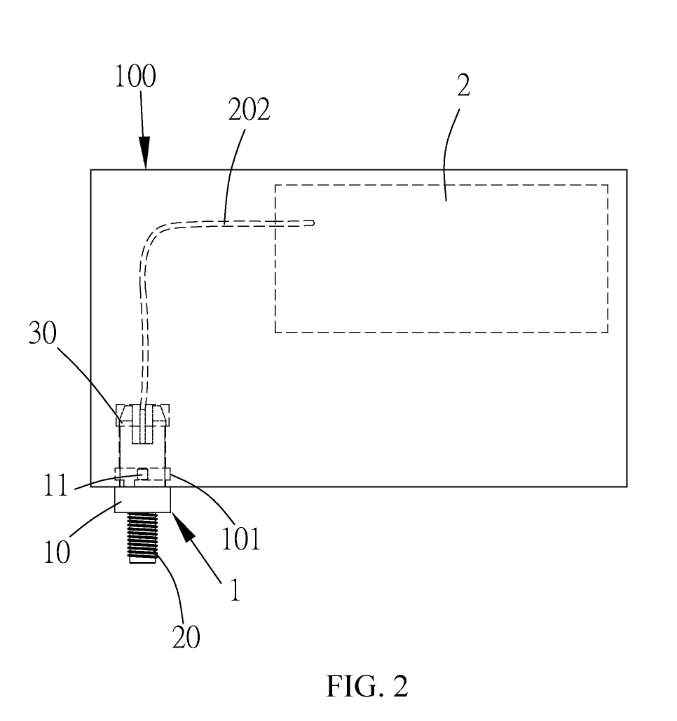

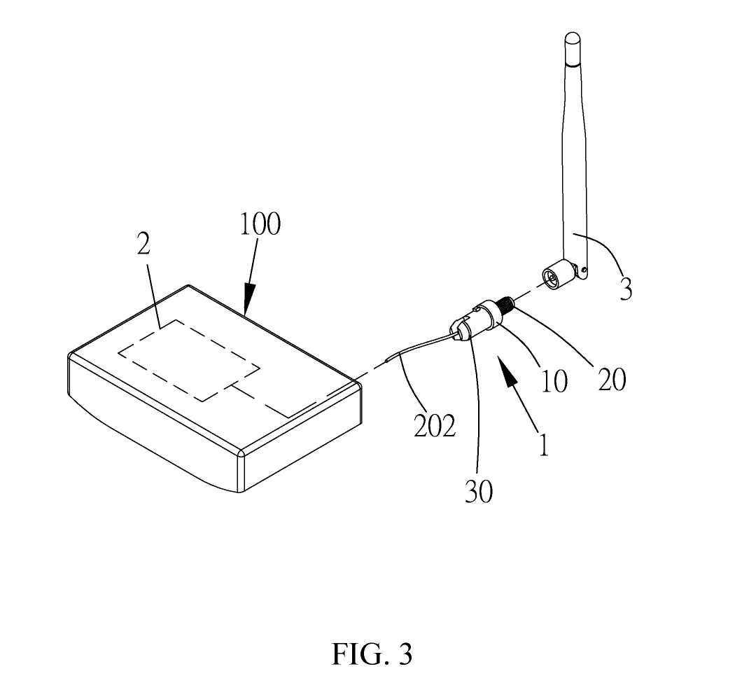

Referring to FIGS. 2 and 3, which respectively are a schematic view and exploded view of the embodiment of the present invention in combination with a wireless access point, the positioning raised block 11 of the connector body 1 corresponds to a positioning groove 101 of a wireless access point 100, allowing the raised ring 10 of the connector body 1 to be positioned on one side of the outer side of the wireless access point 100 when the coupling joint for a replaceable antenna connector is assembled on the wireless access point, while the elastic engagement portion 30 of the connector body 1 corresponds to and is in engagement with an engagement groove of the wireless access point 100, thereby achieving the convenient assembly of the connector body 1. Furthermore, another end of the conducting wire 202 is passed through another end of the connector body 1 and extended to be in connection with a control circuit board 2, and the antenna connecting portion 20 is in connection with an antenna 3, which constitutes the wireless access point 100.

Obviously, the detachable antenna connector cable for a fixed antenna port of the present invention can be directly detached and separated when the antenna 3 is damaged or a user wants to replace a used antenna 3 with a new one.

I claim:

1. A detachable antenna connector cable for a fixed antenna port, comprising:
a connector body, a raised ring being wound around an outer side thereof;
an antenna connecting portion, configured on one end of said connector body, a conducting wire being configured inside said antenna connecting portion, one end of said conducting wire being in connection with said antenna connecting portion, another end of said conducting wire being passed through another end of said connector body and extended outward; and
an elastic engagement portion, configured on another end of said connector body.

2. The cable according to claim 1, wherein a positioning raised block is further configured between said raised ring and elastic engagement portion.

3. The cable according to claim 1, wherein a thread portion is configured around an outer side of said antenna connecting portion.

4. The cable according to claim 1, wherein said elastic engagement portion is constituted by two symmetric buckle blocks.
